(19) United States
(12) Patent Application Publication
(10) Pub. No.: US 2009/0030805 A1
(43) Pub. Date: Jan. 29, 2009

(54) Method and system for immediate home delivery of food prepared using recipes shown on television

(76) Inventor: PRAVEEN SENGAR, (US)

Correspondence Address: PRAVEEN SENGAR, 5662 E FOUNTAIN CIRCLE, MASON, OH, 45040, US

(21) Appl. No.: 11/829,078

(22) Filed: Jul. 26, 2007

(51) Int. Cl. G06Q 30/00

(52) U.S. Cl. 705/26

(57) ABSTRACT

A business method and system for immediate home delivery of meals prepared in a way as demonstrated by a chef on a television program. The chef mentioned herein, may be a celebrity chef, or other chef in general. Food providers (example restaurants) in various geographies where celebrity chef program airs and where there is a good likelihood of demand for their food, enter into a partnership agreement with the television network (or channel) airing the food show in order to prepare the food within reasonable timeframe of the demand, and deliver it immediately upon demand. The method includes prior sharing of celebrity chef television program and recipes details with the food providers so they are prepared to cook and deliver the required food to customers on time. The method includes utilizing mostly existing distribution channels for home delivery of food, though new distribution channels may also be built as required.

### FIELD OF INVENTION

This invention relates to a business method of immediate home delivery of food prepared using the same recipe as shown on television program.

### BACKGROUND OF THE INVENTION

The present invention broadly relates to the way a specific meal can be prepared and home delivered to the customer, on demand. The specific meal here refers to the one that is shown on a television food program by a chef, usually a celebrity chef. The viewers of this program may be interested in enjoying the meal right away, and this invention makes it possible for them to order the same for home delivery, right away.

In the current business environment, if a person wants to order food for home delivery, there are limited options to choose from. For example, a person might be able to order a pizza for home delivery, or Chinese food or other kinds of food as available with local food providers, or various restaurants. The menu of the food available to home delivery is mostly limited to what the food providers serve regularly in its retail outlets, or restaurants.

Many times, if a person wishes to eat specialty food, like the one prepared by celebrity chef as shown on television program, one has to either go to the celebrity chef's restaurant, if it is available within reasonable distance, or one may have to prepare the same oneself, using recipes available from the chefs by way of their websites or books. Again, the exact same food item or dish as shown on television program may not be available in the chefs' restaurants or the viewer may not have the necessary time, skills or motivation to prepare the same oneself from the chef's or food channel's books or websites, leaving the viewer unsatisfied.

The current business methods are, therefore, not complete in providing the meals to the viewers that they watch on television and would also like to eat. The viewer today can only see how good food is made by a celebrity chef, for example, but cannot enjoy or taste the same. To provide full satisfaction to the viewers of such shows, the business of broadcasting such food shows should combine with the business of preparation and home delivery of the same food.

### SUMMARY OF THE INVENTION

For the purpose of discussion in this document, the following terms will be referenced in below described context:
1. Food provider—a restaurant or a chain of restaurants with home delivery options
2. Television channel—a television channel that airs food shows in which chefs demonstration preparation and cooking of meals using their recipes
3. Celebrity chef shows—food shows on television where chefs show the preparation and cooking of meals using their recipes.
4. Celebrity chef—the chef may or may not be a celebrity, and the term is used generically to refer to any chef.
5. Viewer—a viewer of the food show becomes a customer of the restaurant when he/she orders meals for home delivery from the restaurant

The present inventors have realized that there is a level of dissatisfaction among the viewers of celebrity chef shows, resulting from their inability to procure and enjoy the meals as prepared by the chefs, within a reasonable time frame.

This gap between viewing the preparation of celebrity chef meals on television and the viewer's ability to order the same for home delivery is the object of the present invention.

Today, the people involved in the business of broadcasting celebrity chef shows are different from the persons involved in the business of home delivery of meals. This invention attempts to bridge the gap between the two businesses, resulting in a business method that streamlines the presentation of celebrity chef shows on television to the immediate delivery of same food to the viewers who may demand it.

To bridge the gap, the invention suggests that the television channels airing the celebrity chef shows enter into an agreement with local food providers in various geographies where their celebrity chef shows are broadcast, in order that the local food providers prepare and home deliver the same meals as broadcast on celebrity chef shows to the customers who may contact the above said local food providers to deliver the same.

As part of the above said agreement, the local food providers will need to obtain in advance, the schedule of the broadcast of celebrity chef shows, and the recipes that they will be airing that day. This will enable the local food providers to stock up any necessary groceries or other supplies as necessary, and do the prior preparation of meals up to the point where the remaining meal can be completed quickly once ordered by viewer for immediate home delivery.

This invention assumes that the personnel of the local food providers will have enough training and experience to see the recipes of the celebrity chefs and prepare the meals without much need for them to contact the television channel airing the show or the celebrity chef. In the event, the television channel or the celebrity chef feels the need to train the personnel of the local food providers in their ways of preparing meals, or the local food providers themselves feel the need for the aforementioned training, the required training between the two parties can be arranged for in an agreed upon manner.

The invention assumes that the local food providers have the required resources and skills to prepare the meals as shown by celebrity chefs on their television programs and therefore they will be able to prepare those meals with similar quality in terms of taste and presentation as prepared by the chefs themselves. In some cases there may be a need for small investment on part of the local food providers in order to procure more grocery or food items or have their kitchen personnel trained in the ways of the given celebrity chefs. This small investment will be justified for its huge payoffs once the customers start placing orders with them for home delivery upon seeing the celebrity chef show on television.

Finally, once the order for delivery of celebrity chef food is placed with the local food provider, the local food provider will home deliver the same using his/her existing delivery channels. Again there is no need for any further investment into the meals distribution channels for home delivery.

Thus, leveraging the cooking expertise of local food providers, and their existing distribution channels for home delivery of meals, this invention attempts to provide the ability to the viewer of celebrity chef shows to immediately order the same food for home delivery, making the experience of watching celebrity chef shows more complete and satisfying.

### BRIEF DESCRIPTION OF THE DRAWINGS

FIG. 1 is a method of the present invention

FIG. 2 is a portion of the system of present invention

FIG. 3 shows the financial gains of the present invention to specific entities

### DETAILED DESCRIPTION

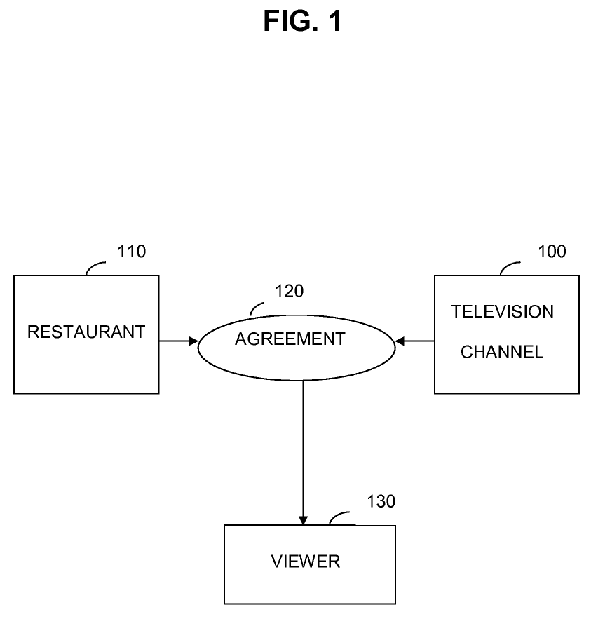

FIG. 1 shows the relationship of a key component of the present invention, the Agreement 120 (an embodiment of a commitment), with its primary beneficiary entities.

The direct beneficiaries are:
1. Television Channel 100 that broadcasts food shows
2. Restaurant 110 (an embodiment of food provider with home delivery options)
3. Viewer 130 (or Customer)

The Agreement 120 is signed between the Television Channel 100 and the Restaurant 110 to service the needs of the Viewer 130 to have celebrity chef food home delivered on demand.

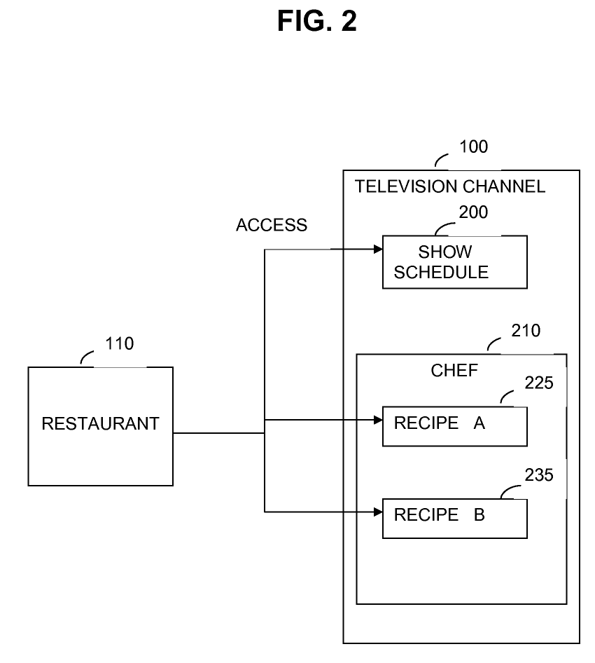

The Agreement 120 can also be between the celebrity Chef 210 (as in FIG. 2) and the Restaurant 110, since the chef is the owner of the Recipes 225, 235 (as in FIG. 2). These recipes are required to be provided to the restaurant in advance of the broadcast of celebrity chef's food show, so that the restaurant gets sufficient time for preparation of the recipes to be delivered immediately when the customer calls.

A limitation of the present invention is that the celebrity chef food may not be available for home delivery prior to the broadcast of the show. This may be due to the fact the sufficient lead time is required in order to do the prior preparations for the celebrity chef food, before customer orders start to come in. Another reason for this limitation may also be that the Agreement 120 between the restaurant and the food channel or chef may prohibit delivery of celebrity chef food to the viewer (or customer) until the show begins to air on television.

FIG. 2 shows the method of present invention, by which the restaurants with home delivery option, will be able to do prior preparations of the celebrity chef food, and ready it for home delivery when the customer demands it.

This prior preparation is very important for timely home delivery since the celebrity chef recipes may require food preparation or cooking steps that take time, and therefore may not be feasible to start these steps once the customer places an order. An example of such a step is marination of chicken or meat for several hours, or preparation of a salad dressing that needs to be refrigerated for several hours before it is ready to serve.

In order to do the prior preparations, the restaurant will need to know following two things in advance, as shown in FIG. 2:
1. Show Schedule 200 of the celebrity chef show that will be broadcast on television
2. Recipes 225, 235 or more that the chef will be demonstrating on his or her show during that schedule

The recipes will let the restaurant know exactly what ingredients will be required for their preparation so that the restaurant may stock up those ingredients that it may not have in sufficient amounts. The restaurant would also come to know if any prior preparations may be required to create the meal, and how much time those preparations may take.

The show schedule will let the restaurant know exactly what date and time the celebrity chef show will be broadcast. This will give the necessary time to the restaurant to stock up any necessary groceries and do any prior preparations as may be required for the given recipes.

The timely sharing of show schedules and recipes will be part of the Agreement 120. These schedules and recipes can be shared well in advance, for example a day in advance or perhaps even weeks or months in advance. This will be determined by the signatories of the Agreement 120 per their business requirements.

An embodiment of the system to share this information on schedules and recipes can be a website owned or maintained by the television channel. The television channel will update the schedules of its celebrity chef shows and their recipes that they will be demonstrating on those particular shows. The recipes can be in the form of text with pictures of the final dish, and may also include pictures of intermediate stages of preparation and cooking of the meal. The recipes can also be in the form of a video of the show that has been uploaded to the website.

The restaurants that signed the agreement will have secure (authenticated) access to the website to view or download the show schedules and recipes, so they can prepare the same in a timely manner. As described in the agreement, this access to restaurant to view or download the show schedules and recipes may be limited for a specific period of time for each show, or it can be unlimited.

In this embodiment of the above said website, each restaurant or its owner may be provided with a login id and password to authenticate itself in order to access the show schedules and recipes.

Once the restaurant has prior access to the show schedules and recipes, it can do all the prior preparations and ready itself to complete the preparation of celebrity chef meals in time for home delivery, when the customer calls. The restaurant mentioned herein, will already have home delivery system set up and can leverage the same to service its customers.

As part of the Agreement 120, or otherwise, the television channel may also share data about this viewership with the restaurants entering into agreement with it. This data may contain numbers as to how may people view which food shows, by geography if possible. This will give an estimate for the number of home delivery orders the restaurants are likely to get for a given show.

Another system of the present invention is to make available the contact information of the restaurants that will be able to home deliver the celebrity chef meals as shown on television. An embodiment of this system is the publishing of this information by the television channel on its website. In this embodiment, the viewer who is interested in home delivery of celebrity chef food, can go to the website of television channel, and by entering his or her location (address or zip code), will get the listing of all restaurants in the area that deliver celebrity chef food. The listing may also provide information on what chefs the specific restaurants cover for home delivery. For example, a restaurant A may deliver meals prepared only by Chef X, while restaurant B may deliver meals as prepared by Chefs X and Y. This may depend on the capabilities of individual restaurant or on the clauses as signed in Agreement 120.

Another embodiment of making the contact information available is through the use of existing advertising methods used by the restaurants. One of these is the distribution of pamphlets promoting their food. In the same pamphlets, the restaurants may include the name of the television channels and chefs whose meals they will be able to provide for home delivery. They may also include a date until which the particular recipes may be available for home delivery. Alternatively, the restaurant may also provide all this information upon its website.

Along with providing immediate home delivery of meals as shown on air by a celebrity chef, the restaurant may also be able to provide home delivery for back dated shows of celebrity chef meals, for a particular period of time. For example, a restaurant can provide home delivery for all or some of celebrity chef shows for up to a few days, weeks or even months, after which those meals may no longer be available for home delivery.

The present invention leverages upon the fact that the chefs of various restaurants shall be skilled enough to be able to prepare the same meals as shown on celebrity chef shows, using the recipes provided and watching the videos of their shows. In some cases, if it is deemed that the chefs may need specific training to acquire the skills for preparing meals from a particular chef or all chefs in general, the said training can be arranged for by the television channel 100 or the chefs 210 or another organization affiliated with the television channels or the chefs. This training shall impart the necessary skills to the chefs of various restaurants, and upon its completion they will be able to prepare the meals of celebrity chefs in ways that the chefs themselves would have prepared, thereby rendering a good quality to the meals that will be served to the customers. At the end of the training, there should be minimal difference, if any, between the meals as prepared by chefs of various restaurants and the same meals as prepared by the celebrity chef himself/herself. This way the customer will get same the satisfaction as if the meal was prepared by the celebrity chef himself/herself.

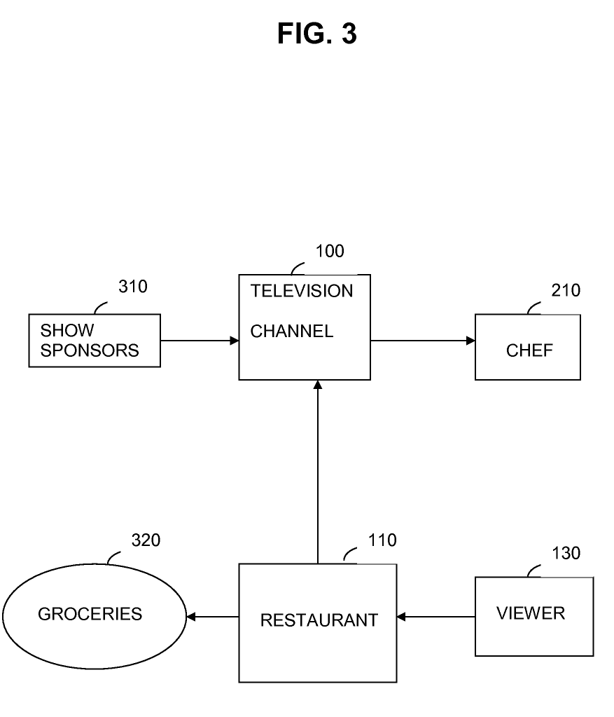

In conclusion of this invention, the inventors would like to demonstrate the financial gains to various entities involved. FIG. 3 shows the various entities that are part of this business method and system:
1. Television Channel 100
2. Restaurant 110
3. Viewer 130
4. Chef 210
5. Show Sponsors 310

The direction of arrow in FIG. 3 shows the direction of money flow to various entities.

Once a business model is setup to provide the viewer with home delivery of celebrity chef meals, the Television Channel 100 shall have more viewers for its celebrity chef shows, since the viewers now know that they can not only watch the celebrity chef shows, but can also taste the same food immediately by ordering it for home delivery, if they wish to.

The increase in viewership of such shows will likely result in increased sponsorships for such shows. The television channel will be able to charge more money from sponsors of its celebrity chef shows.

Accordingly, due to increased popularity of the shows, the celebrity chefs will be able to charge more money for their shows. Thus, the chefs stand to gain from this invention.

By signing agreement with the restaurants to provide advance schedule and recipes of celebrity chef shows, the television channel will receive payment from the restaurants for signing such agreement. Thus, television channel will increase its revenues using the business method of the present invention. It will have increased revenues from the agreements it signs with various restaurants as well as from the sponsors of its celebrity chef shows.

The restaurants will incur a cost to pay for the agreements with television channels, and will also incur a cost to procure any additional Groceries 320 or other supplies that may be required to prepare the required celebrity chef meals. However, they will increase their customer base by now serving a new set of customers who order celebrity chef food for home delivery from their restaurant. This will result in increase in sales that will be able to cover for the cost of agreements with television channels and additional groceries and supplies and still provide more profits to the restaurant, thus increasing the overall income for the restaurants participating in this business model.

Finally, the viewers of celebrity chef shows on television will be able to satisfy their desire to have celebrity chef meals served to them at their home within a reasonable time for home delivery, while also adding to the incomes of various entities involved in making this possible.

What is claimed is:

1. A business method that allows a viewer watching a food show on television to order the same meals that the viewer has just seen on television, for immediate home delivery, wherein the food show comprises of a chef demonstrating the preparation of meals using plurality of recipes;

2. The business method of claim 1, comprising of a commitment between television channel that airs the food shows and the food providers that do home delivery in various geographical locations covered by the television channel, to give rights to the food providers to create and home deliver the meals that are shown on television channel's food shows. This commitment may take the form of a signed contract to purchase the required services of the television channel that will assist the food providers in timely creation and delivery of meals. It may also be a statement of intent, letter of authorization, or other type of business commitment satisfactory to the food provider as well as the television channel.

3. The business method of claim 2, wherein the commitment can be between the chefs of the food shows on television, and the food providers

4. A method of claims 2 and 3, wherein access to recipes and schedule of television channel's food shows are made available to the food providers, ahead of the broadcast of the food show, by several days, weeks or even months

5. An embodiment of the system of claim 4, wherein the food providers can view the recipes on the television channel's website ahead of time, print them or download them for later usage

6. Another embodiment of the system of claim 4, wherein the food providers can view the actual video of the food show ahead of time. The video will be aired on television channel at a later date or time

7. A method of claim 2, wherein the television channel may share data about its viewership with the food provider

8. An embodiment of the method of claim 2, wherein the contact information of the local food provider that will provide the meals shown on television can be obtained via television channel's website

9. Another embodiment of the method of claim 2, wherein the food providers advertise about the food shows they cover along with their contact information for home delivery, by way of advertisement pamphlets or their website

10. Another embodiment of the method of claim 1, wherein the viewer may request home delivery for meals shown on a prior date on television, for up to a set period of days and the food provider will be able to provide the same

11. A method of claim 1, further comprising of the training of chefs or personnel of the food providers, by the television channel or its chefs or a training organization affiliated with them
